(19) United States
(12) Patent Application Publication
(10) Pub. No.: US 2014/0285357 A1
(43) Pub. Date: Sep. 25, 2014

(54) System and method for analyzing the energy consumption of electric loads in a consumer network

(71) Applicant: yetu AG, Berlin (DE)

(72) Inventor: Christopher SCHLAEFFER, Bonn (DE)

(21) Appl. No.: 14/215,162

(22) Filed: Mar. 17, 2014

(30) Foreign Application Priority Data
Mar. 15, 2013 (EP) 13 159537.3

(51) Int. Cl. G01D 4/00; G06F 17/50

(52) U.S. Cl. CPC G01D 4/002; G06F 17/5009
USPC 340/870.02; 703/18

(57) ABSTRACT

The method for analyzing and displaying the energy consumption of electric loads according to the invention comprises, in principle, the following steps: providing at least one consumer network comprising a plurality of interconnected electric loads; sampling the total current, voltage and phase shift of the consumer network with a sampling rate of less than 5 Hz; transmitting the sampled measured data through the internet to a means for load recognition; receiving the sampled measured data through the internet by the means for load recognition; determining individual loads in the measured data by the means for load recognition, comprising: determining temporal regularities of individual loads by means of a spectral analysis of the measured data, and/or generating load models for individual loads by modelling individual phenomena in the measured data by means of classifiers, and visualizing the energy consumption in the consumer network.

### CROSS-REFERENCE TO RELATED APPLICATIONS

This application claims priority to and the benefit of European Patent Application no. 13 159 537.3, filed Mar. 15, 2013, the contents of which are herein incorporated by reference in their entirety.

### FIELD OF THE INVENTION

The present invention relates to a system and method for analyzing the energy consumption of electric loads in a consumer network. In particular the invention relates to a system and method for determining the energy consumption of individual loads in a private household solely on the basis of the values read out from an electricity meter. The system is called Home Energy Management System (abbreviated HEMS).

### STATE OF THE ART

It is known to determine the energy consumption, for instance in an apartment or a detached house, by means of a so-called “electricity meter”. This meter serves for accounting for the energy consumption in relation to the electric supply company and determines the energy taken from the mains on the basis of the instantaneous values of current and voltage. However, this requires a person to read out the energy consumption. Consumption is usually accounted for once a year. For that reason the consumers have very little transparency with regard to the cost caused by individual loads in their consumer network.

Recently, so-called “intelligent electricity meters” or “smart meters” have been installed in private homes. Intelligent electricity meters are equipped with a processor and can transmit collected data automatically through the internet to the electric supply company. By connecting the electricity meter in private households with the internet it is in principle possible to carry out interactive evaluations of the power consumption. However, this allows only to represent the total consumption; it is not possible to show the consumption of individual electric loads in a private home.

On the other hand smart electric loads are known that are able to determine the power consumption costs by themselves by entering the price for electricity. Yet, only few products offer this option. Moreover it is difficult for the users to keep track of the costs if they have to be taken from each device separately.

In addition to the above, GB 2461915 A discloses a device for measuring consumption which discloses non-invasive monitoring of the consumption of an individual load by means of a sensor that is provided separate from the electricity meter and that is combined with analysis software. It collects data with a frequency of 50-60 Hz.

However, installing a separate current sensor increases costs. An intelligent electricity meter usually samples energy consumption with a much lower frequency of a few hertz only. The low sampling rate makes it difficult to determine individual loads comprised in the scanned signal.

For that reason there is still a need for a low-cost and simple solution for automatically recognizing individual electric loads in a consumer network with several loads.

### DISCLOSURE OF THE INVENTION

The method for analyzing and displaying the energy consumption of electric loads according to the invention comprises the following steps: providing at least one consumer network comprising a plurality of interconnected electric loads; sampling the total current, voltage and phase shift in the consumer network with a sampling rate of less than 5 Hz; transmitting the sampled measured data through the internet to a means for load recognition; receiving the sampled measured data total current, voltage and phase shift via the internet by the means for load recognition; determining individual loads in the measured data by the means for load recognition, comprising at least one of the following steps:
determining temporal regularities of individual loads by means of a spectral analysis of the measured data, and
generating separate and/or common load models for individual loads by modelling isolated phenomena in the measured data by means of classifiers, and
visualizing the energy consumption in the consumer network.

The method applied is based, in principle, on the disaggregation of loads in private households solely on the basis of the data of commercially available electronic electricity meters.

The advantage of the technical approach is that conventional intelligent electricity meters, the “smart meters” can be used. The measuring and analysis function does not require additional devices to be installed in the homes. The disadvantages of data measurement that occur when using conventional electronic electricity meters, in particular the low measuring frequency, are counterbalanced by intelligent analysis methods. It is not necessary to install new, expensive electricity meters or additional measuring instruments and the overall solution is economical.

The method uses the data that is measured anyway by the electricity meter and analyses it. The electricity meter measures the total consumption at the measuring point, i.e. for the entire household. Further, it measures some secondary parameters such as reactive power and phase shift. Moreover these data is provided with a very low frequency of 1 Hz. This is a legal requirement in Germany.

The method applied can be called “low frequency sampling” (LFS) and it influences the methodology of automatically recognizing the electrical appliances that are switched on in a household on the basis of feature extraction and pattern recognition methods for recognizing individual devices and for disaggregating electric loads on the basis of the data provided by a smart meter.

The method is based on measurements by a digital electricity meter (smart meter) with a sampling rate of 1 Hz for the parameters “current”, “voltage” and “phase shift”. These are used to obtain the main features, i.e. apparent, effective and reactive power. The measured data for current, voltage, phase shift as well as the main features resulting from them are the basis for feature extraction and the classification methods.

The separate and/or common load models can advantageously be used additionally for “machine learning” methods that serve for automatically improving the recognition system.

In an exemplary embodiment only separate load models for individual loads are generated by modelling isolated phenomena in the measured data by means of classifiers.

Preferably there is a plurality of consumer networks, and in the means for load recognition the measured data from the plurality of consumer networks are used for determining individual loads in a consumer network.

By simultaneously using measured data from other devices in the home classification becomes easier in as far as it becomes easier to recognize similar patterns.

Moreover, the user can confirm or change the recognition of loads in the consumer network through a web service. The user can exercise direct influence here and this influence can be taken into account for load recognition in other consumer networks.

Spectral analysis is used for long-term recognition of loads in the measured data. It can also be used additionally or alternatively for confirming or substantiating the early recognition of isolated or single phenomena in the measured data.

The sampling frequency is preferably less than 2 Hz, even more preferably it is less than or equal to 1 Hz and greater than or equal to 0.5 Hz, preferably greater than or equal to 0.2 Hz. The energy resolution of the sampling is less than 5 watts, preferably less than 2 watts. Even more preferably it is 1 watt.

User profiles, historical data, weather data or seasons may be taken into account for feature extraction. This provides for an enhanced classification.

In addition, a system for analyzing and displaying the energy consumption of electric loads is proposed. The system comprises: a consumer network comprising a plurality of interconnected electric loads; an intelligent electricity meter that is electrically connected with the consumer network and that is suitable for sampling the total current, voltage and phase shift of the consumer network with a frequency of less than 5 Hz and greater than or equal to 0.2 Hz; a communication module with a first data memory that is suitable for reading out the measured data of the intelligent electricity meter and storing them in a buffer, a home gateway for reading out the measured data from the communication module and transmitting the measured data through the internet; a data collection for receiving the measured data transmitted by the home gateway; a means for load recognition for recognizing individual loads in the consumer network on the basis of the received measured data; and a visualization unit for displaying the energy consumption of the loads in the consumer network.

The communication module is preferably integrated in the intelligent electricity meter, this means it is part of the electricity meter.

A plurality of consumer networks may exist. In the means for load recognition the measured data from the plurality of consumer networks will be used for determining individual loads in a consumer network.

Advantageous further developments of the invention are mentioned in the subclaims and described in the description.

### DRAWINGS

Exemplary embodiments of the invention are explained in greater detail with reference to the drawings and description below, in which

FIG. 1 shows a block diagram of a system for analyzing the energy consumption of electric loads according to the invention,

FIG. 2 shows schematically the basic sequence of the classification and recognition method,

FIG. 3 shows the input signal of a washing machine,

FIG. 4 shows the Fourier transform of FIG. 3,

FIG. 5 shows the Fourier transform of the input signal of a tumble drier,

FIG. 6 shows a model according to the invention of the classification on the basis of spectral analysis,

FIG. 7 shows a scatter plot of coefficients obtained by a spectral analysis,

FIG. 8 shows a result of an analysis of an isolated or single phenomenon according to the invention,

and

FIG. 9 shows a model of an analysis of an isolated or single phenomenon according to the invention.

### EMBODIMENTS OF THE INVENTION

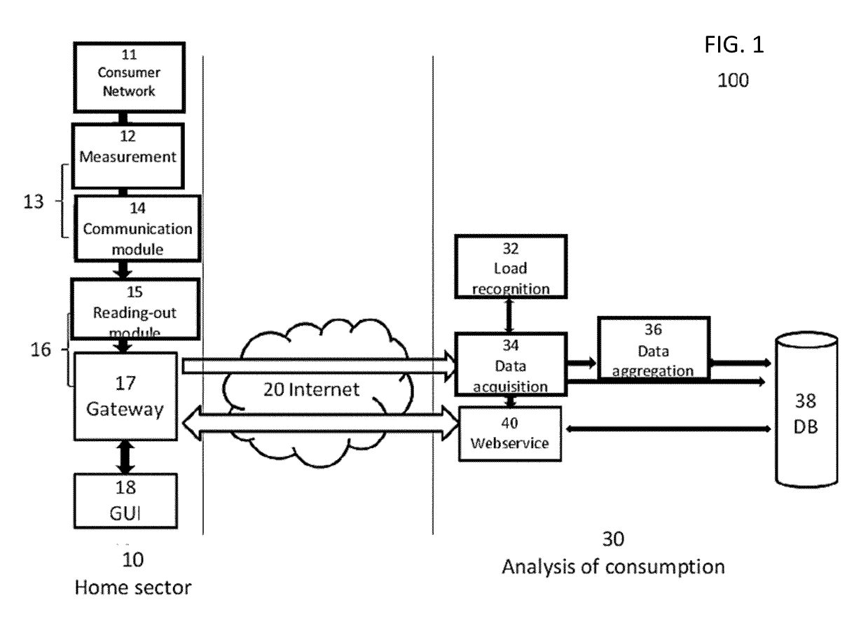

FIG. 1 shows a system 100 according to the invention for analyzing the energy consumption of a system of electric loads 11. The system 100 can be divided vertically into three sectors. The home sector 10, the internet 20 and the consumption and load analysis 30 on a server that is remote from the home sector 10.

Herein the home sector 10 consists of a system of electric loads 11. “Home sector” in this context means a private household. It may be an apartment, a detached house, a semidetached house or similar unit. In the home sector 10 the intelligent electricity meter 13 provides each second information on the energy consumption parameters total current, voltage and phase shift. These can be used to determine the apparent, effective and reactive power. This is done for the entire household. This means that the electricity meter 13 does not identify individual loads in the system of loads 11. Further, a load 11 is not associated with a separate sensor for identification of its power consumption.

The sampled values of the measurement 12 are read out by a communication module 14 and transmitted to the partner unit 16, the so-called home gateway, for transmitting the data, preferably after encoding, to a means for load recognition 32, abbreviated as load recognizer, on a server that is remote from the home sector 10.

The intelligent electricity meter 13 according to the invention provides for external use the values for current, voltage and phase shift with a sampling rate of less than 5 Hz, preferably less than 2 Hz, even more preferably with a sampling rate of less than or equal to 1 Hz and greater than or equal to 0.5 Hz, preferably greater than or equal to 0.2 Hz. The power values have a precision (resolution) of less than 5 watts, preferably less than 2 watts, even more preferably of 1 watt.

The intelligent electricity meter 13 is connected with a communication module 14. In a preferred embodiment the communication module 14 is directly installed in the intelligent electricity meter 13. The communication module 14 electronically reads out the measured data 12 sampled by the electricity meter 13, stores them in a buffer and keeps the stored values ready for the partner unit 16. The connection between the partner unit 16 and the communication module 14 can be provided by power cable (Power Line Communications, PLC), wireless interface or directly by a cable specially installed for this purpose.

The partner unit 16, i.e. the home gateway, is a special device that is located in the home sector of the user. It connects with the communication module 14 and reads out the provided measured data. These measured data are provided for consumption analysis 30 through an interface and the internet 20. This may be done by means of a wireless system or a cable.

The partner unit 16 consists of a reading module 15 and an internet gateway 17. The reading module 15 and the internet gateway 17 may be arranged together in one device, the home gateway, but they may also form two separate units. In the latter case the internet gateway 17 may be constituted by an ordinary internet router. In that case only a reading module 15 has to be arranged between the communication module 14, which is preferably integrated in the intelligent electricity meter 13, and the internet gateway 17. This simplifies installation further.

The partner unit 16 connects with a data collection 34 through the internet 20. A check is carried out to determine whether the partner unit 16 is known. In case an unknown partner unit 16 connects with the data collection, all data will be rejected. In case the partner unit 16 is recognized as a known unit, the data will be conveyed for further processing and/or stored for preventing the loss of data in case the connection is interrupted.

In addition, the partner unit 16 may serve as central internet access in the home sector 10 and may provide for the end user a portal function that may be used through the TV, a mobile device or a computer. In one exemplary embodiment various network connections may be provided in the partner unit 16 for this purpose.

From the data collection 34 the sampled measured data on the server are transmitted to the load recognizer 32. The data is stored in a buffer for a certain period and will be deleted only when a shutdown event is recognized for the load. Preferably the data is also conveyed to a data aggregation unit 36, a database 38 and a web service 40.

In the load recognizer 32 the measured data are pre-processed and the data that are already recognized are extracted from the current data record. The measured data are processed in the recognizer and changes are recognized. The unit is able to recognize, for instance, switching on or off as an isolated or single phenomena. Other isolated phenomena can, for example, be slow or rapid changes of consumption (flashing).

The measured data are aggregated in the data aggregation 36 using new data and historical data from the database as required by the interval, so that, for instance, the consumption of a recognized load is calculated for a pre-determined period. For instance, data that is sampled once per second is collected to aggregate it in pre-processing for a period of 5 min, for instance. The measured data are aggregated for the individual loads. In addition, the total consumption is aggregated, that is total consumption per household.

The database 38 transmits data also to the data aggregation 36. Here processes are initiated for aggregating to one hour the data that were aggregated to 5 min, for aggregating the hours to the day, the days to the week, the weeks to the month and the months to the year.

The load recognizer 32 notifies the data collection 34 if a new load has been recognized in the consumer network 11 (switch on), if a load is not recognized anymore (shutoff) or if the consumption of a recognized load has changed.

The data collection 34 transmits to the web service 40 the events that have been recognized in the measured data. By means of the web service the user may also transmit a feedback to the data collection 34 for improving the recognition results per home sector. This feedback can then be conveyed to the load recognizer 32. The user can confirm that the recognition is correct or indicate that the recognized “device” is to be placed in a different class. The user can also correct wrong recognition results.

The web service 40 can transmit the displayed data and/or the feedback to the database 38 for archiving. Additionally, when the user logs in, all “historical” data up to the time of the user's logging in can be transmitted for visualization from the database 38 to the web service 40.

Lastly the data is visualized for the user by the web service 40, e.g. a browser. The data can also be transmitted to the home sector 10 and be displayed there by means of a graphic user interface 18. However, preferably visualization is done by means of a web service 40, which gives users the opportunity to analyze and visualize their power consumption at any place. It is also possible to display the power consumption both in the home sector 10 and by means of the web service 40.

The method applied in the load recognizer 32 is based on the disaggregation of loads in private households solely on the basis of the data provided by commercially available electronic electricity meters 13.

Since the data is supplied with a very low frequency of less than 5 Hz and greater than or equal to 0.2 Hz the measured signal changes are processed and analyzed on the macro-level of signalling.

The measuring and analysis function advantageously does not require additional devices to be installed in the home. Therefore it is not necessary to install new, expensive electricity meters 13 or additional measuring instruments and the overall solution is more economical. Additional devices are used only for transmitting the measured data.

The solution is based on combining advanced methods of artificial intelligence. The disadvantages of data measurement that occur when using conventional electronic electricity meters 13, in particular the low measuring frequency, are counterbalanced by intelligent analysis methods.

The features of current, voltage and phase shift provided by the intelligent electricity meter 13 are the basis for the main features of apparent, effective and reactive power. The latter are the basis for feature extraction and for the classification methods. Other features that are taken into account are user profiles, historical data, weather data and seasons as well as other knowledge-based sources.

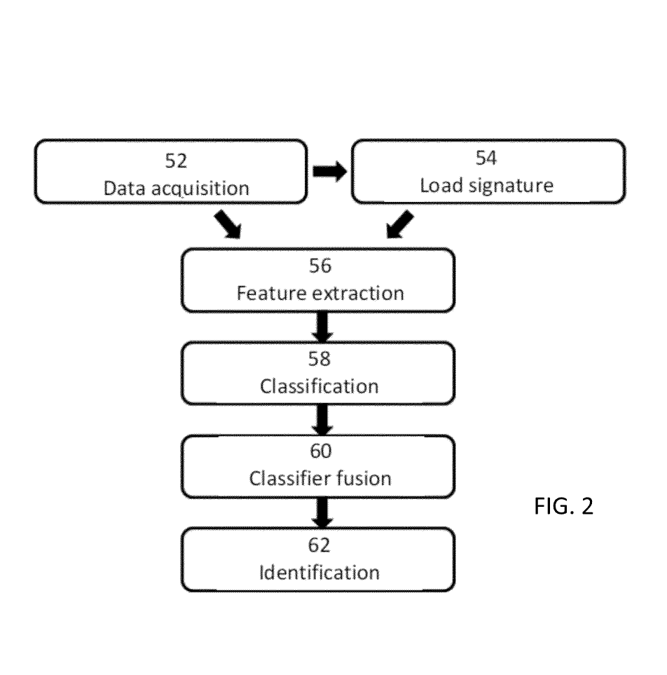

FIG. 2 shows schematically the basic sequence of the classification and recognition method. First the data is acquired 52, features are extracted from the signal 56 and classified in different ways 58. The individual classifiers are combined 60 and eventually a load is identified in the measured data.

The electrical appliances in private households can be subdivided into four classes with regard to the complexity of their states:

| Class | Description |
|---|---|
| 1 (constant | The device has a single state with constant |
| consumption) | consumption, not regarding any limited variation, |
| | examples are lamps, toasters, electric kettles, |
| | telephone systems, HiFi devices on stand-by |
| 2 (fixed | The device is characterized by a deterministic |
| sequence) | sequence and duration of states. Examples: |
| | dishwasher, washing machine, tumble drier, |
| | microwave oven |
| 3 (variable | The device has several states whose sequence |
| sequence) | cannot be anticipated but is controlled dynamically by |
| | the system or the user, examples are coffee machine, |
| | oven, refrigerator |
| 4 (highly | The device has one state only that does not have a |
| variable) | recognizable pattern or whose variance is too great, |
| | examples are PC, drilling machine |

The core task is to disaggregate the simultaneous running of several loads and to scale the method for simultaneous operation in a number of n households.

The present invention works on the basis of adapted methods of artificial intelligence, in particular of signal processing and pattern recognition, that are able to recognize individual load profiles in a complex, superimposed signal and to allocate them correctly to classes of devices. Algorithms and classifiers of artificial intelligence are used for generating profiles of individual loads. They are based on time-related logics and on logics based on isolated phenomena, which may interchangeably be called single phenomena. Additionally, combinations of classifiers are allocated to individual classes of devices.

The method applied is a methodology of automatically recognizing the electrical appliances that are switched on in a household on the basis of feature extraction and pattern recognition methods for recognizing individual devices and for disaggregating electric loads on the basis of data provided by an intelligent electricity meter 13. The methods that are used within the framework of the recognition methods for non-intrusive recognition of loads in households are based on two basic principles. On the one hand temporal regularities of individual loads are modelled by spectral analysis on the macro-level. This principle will be called spectral analysis below. On the other hand one or several characteristic isolated phenomena are modelled by special detectors that are called feature extractors. This method is called analysis of isolated phenomena, or interchangeably, analysis of single phenomena. In the analysis of isolated phenomena the profiles of individual loads are reflected in a separate and/or common model so that loads can be directly identified during operation.

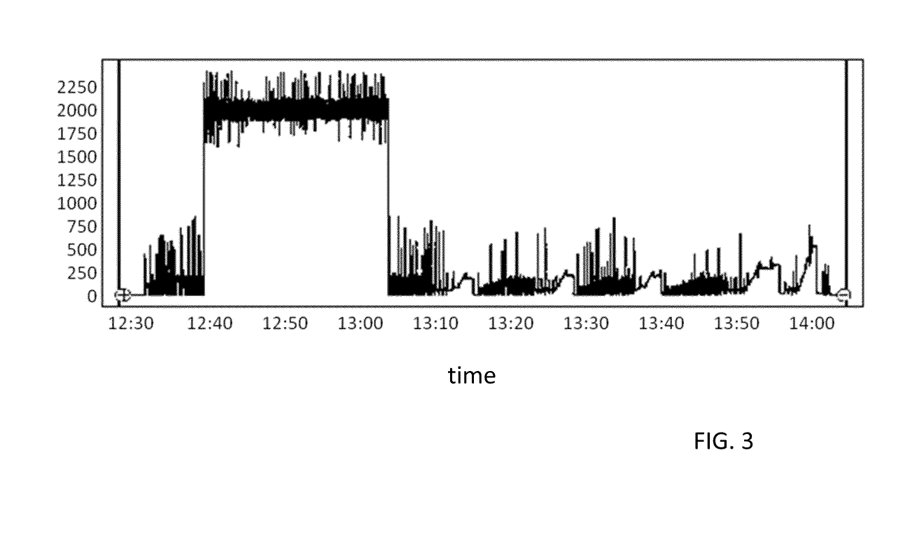

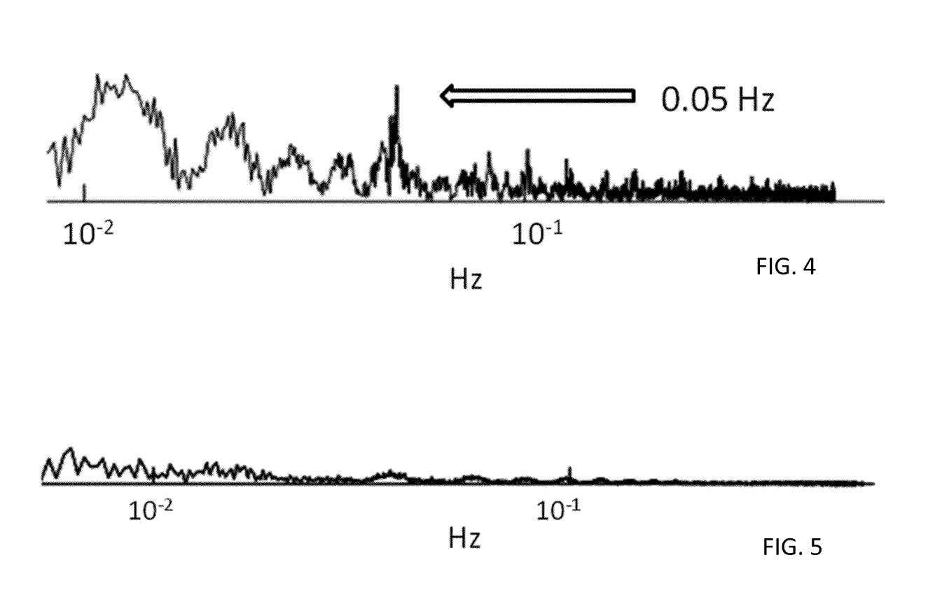

First we describe spectral analysis in greater detail. Spectral analysis of an input signal S of a load is usually done by means of a Fourier transformation where the input signal S as function of energy over time is transformed into a three-dimensional graph of time, energy and frequency (the so-called pictogram). FIG. 3 shows, for example, the input signal S of a washing machine. The Y axis shows the effective power. The signal shows regularities that correspond with the program sequence of the washing machine. The regularities repeat with varying frequency; the longer the distance between two instances, the lower is the frequency. FIG. 4 shows the same signal as a frequency graph (frequency as function of time) after Fourier transformation. It shows clearly identifiable patterns that correspond with the regularities in the previous graph. Most characteristic is the rise (marked with an arrow) at a frequency of 0.05 Hz which stands for a repetition rate of 20 seconds. This pattern of rises in the frequency graph can be considered as the individual fingerprint of the washing machine. For comparison, FIG. 5 shows the obviously different fingerprint of a tumble drier from the same data collection.

The difference between this analysis and classical cases where a Fourier transformation is used, as for instance in digital acoustics, is that the frequency of recurrence is in the macro-range. This allows for spectral analysis to be carried out even with a very low measuring resolution, e.g. of 1 Hz. However, a consequence of this is that values have to be recorded for a relatively long period before the temporal phenomena become visible. In the case of the marked rise for the washing machine we have to wait for at least 20 seconds until the expected energy consumption can be detected at 0.05 Hz.

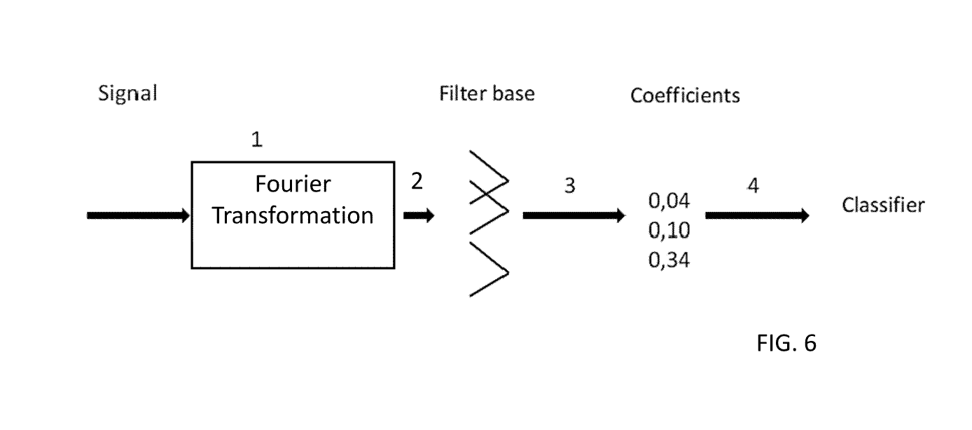

Advantageously, spectral analysis allows to detect regularities in the frequency domain even if the signal is noisy. “Noise” means changes in the signal S that are not related to the “wanted” load, i.e. other loads or interference. FIG. 6 is a schematic representation of the spectral analysis according to the invention. A signal is first Fourier-transformed, then filtered, coefficients are extracted and a classifier is generated.

First a Fourier transformation is carried out on the basis of the original signal (step 1). Then a filter base is applied (step 2) for converting the relevant frequency ranges in the signal into discrete values (coefficients) (step 3) which are then the actual feature vector that is fed into a classifier (step 4). In the example of the washing machine the peak of one of the filters is then at 0.05 Hz. This filter will return a high value for the washing machine while the tumble drier, for instance, would rather generate a low value. The same applies for all other filters.

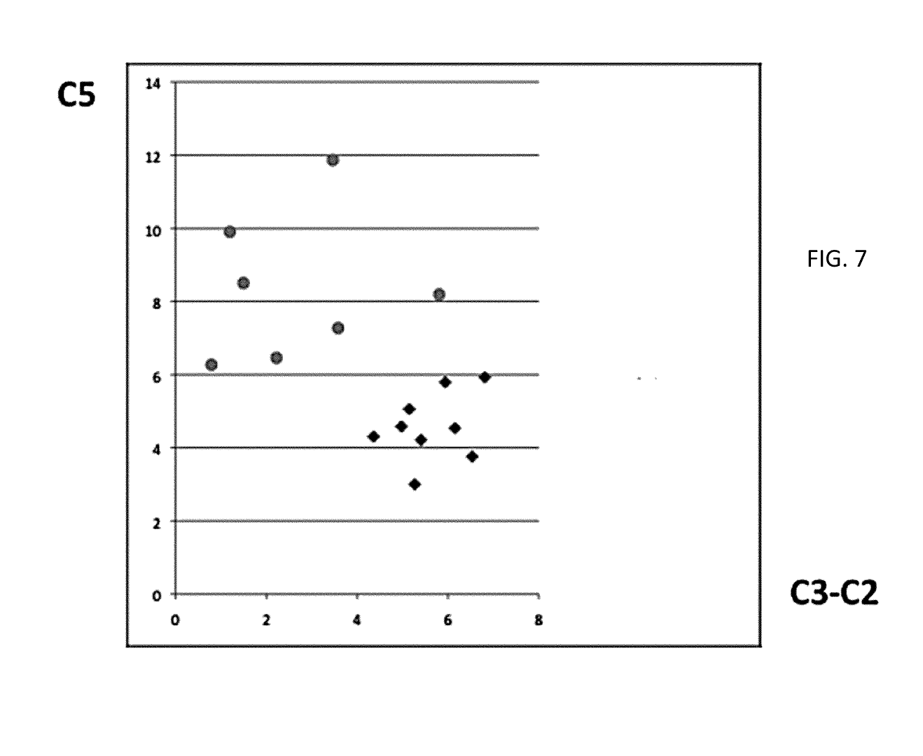

Considering then, as shown in FIG. 7, only the coefficients that were generated by spectral analysis (without step 4, i.e. without a complex learning algorithm) the differentiating power of the method is already obvious. FIG. 7 is a so-called scatter plot. This is a two-dimensional projection of the feature space that results from a simple linear combination of the calculated coefficients. The circles are values from several runs of the washing machine (also with different settings of the machine), the diamonds are other devices for comparison (here: tumble drier, dishwasher). It is obvious that a classification with a precision of 100% can be achieved by choosing a suitable decision function.

Parallel with spectral analysis the so-called isolated phenomenon analysis is carried out.

As an example for marked isolated phenomena the following will explain discontinuities of the measured data for power by −Δ and +Δ, i.e. “leaps” upward and downward, that are measured separately and in relation with each other. In addition to the discontinuities the length (time) of a pulse between +Δ and −Δ is measured. This creates clusters that are allocated to certain loads. The location of the marked clusters and their position in space are characteristic features. In addition, classification of isolated phenomena takes into account user profiles and knowledge-based approaches for making more precise estimates of the probability of recognition.

When the number of features grows (higher-dimensional feature vectors) the known methods are applied for creating a correspondingly complex differentiation line. Among these methods are “Multilayer Perceptron Artificial Neural Networks” (MLP ANN) and “Support Vector Machines” (SVM).

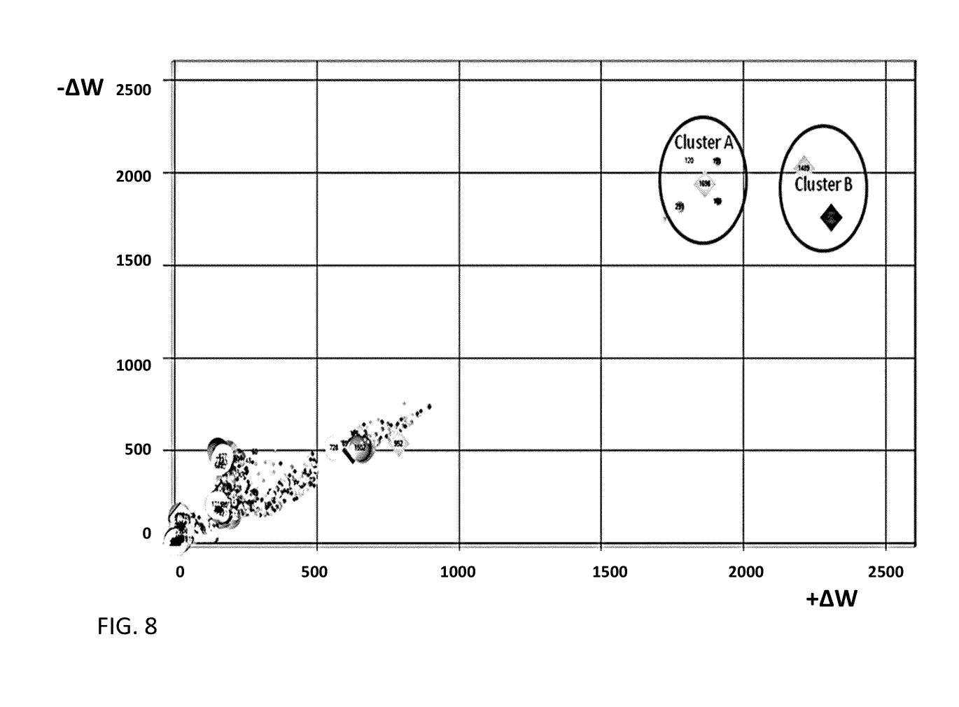

Such an analysis of the washing machine is shown in FIG. 8. The location of the marked clusters and their position in space are characteristic features. In this example simple threshold values can be used for differentiating between the washing machine(=“target”) and other devices(=“non-target”).

More specifically, various methods are used for analyzing isolated phenomena and some examples of these methods are explained below.

Electric loads basically can be classified as resistive loads, inductive loads and capacitive loads. In reality, mixed loads occur which consist of combinations of these three basic load types. For that reason it is necessary to use classification methods that support the most varying types of recognition approaches on the one hand and allow or use a combination of results (classifier results) and also support a hierarchic re-classification.

For covering the widest possible recognition space the various loads are divided into main classes which are further divided into sub-classes in a second step. The purpose of this step is to allocate the individual classification methods suitably to the various loads and to re-combine them on a higher level after recognition. A range of different basic classifiers is used for this step. Additional meta-classifiers are used for optimizing the recognition results.

The classifier “BlockLoad” recognizes typical “block loads” such as toasters, electric kettles, hairdryers, blenders, etc. These are loads that do not show significant changes of energy consumption while they run. While the set program runs or the output remains constant (e.g. hairdryer stage 1, 2 3, etc.) the energy consumption remains constant. Recognition is based on the delta discontinuity at the beginning or respectively at the end of a block consumption and the instantaneous consumption between the changes.

Like “BlockLoad” the classifier “Extremum Delta” is based on a delta change of consumption. It can also differentiate between several interconnected blocks. This is done by sorting discontinuities of a certain number and length into device-specific “clusters”.

“FrequencyCoefficients” is based on Fourier transformation and transforms the signal into the time range. The classifier extracts the spectral coefficients for creating a feature vector.

“StateMachine” is used in case loads have a constant sequence of “states”. Such a load has strictly defined transitions from one state to the next.

A “MarkovModel” is used in case devices have a dynamic sequence of “states”. This model shows probabilities of transitions between states.

“SimpleThreshold” uses metrics with varying delta discontinuities for recognizing loads where continuous rises and drops of consumption happen during the running time. It defines the frequency of threshold value changes (delta discontinuities) across the sequence of periodically recurring features.

The following meta-classifiers can also be used: “LongTerm” bridges periods of “zero consumption” for devices that do not show clear patterns over the entire running time, e.g. a refrigerator or a deep freezer. These loads are permanently “on” while consuming very little or no energy. The classifier “Windowed” takes into account the last X seconds instead of only the last classification event and thus prevents flashing during recognition. “RealReactiveCrossover” takes into account the crosswise change between apparent and reactive power during running. This classifier is used in particular for devices that work with very high internal frequencies (e.g. microwave ovens).

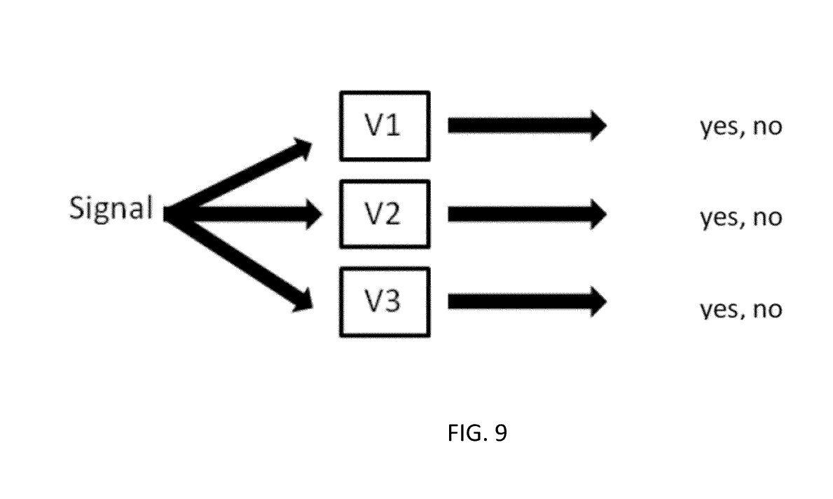

Defining the problem of recognition is equally important. The present invention uses the so-called “detection task”. As shown in FIG. 9 this means that for each load a separate model is created which shows whether the respective load(=“target”) is included in the signal or not. Changes in the load mix only lead to the activation or deactivation of models in this case. In addition, it allows for a better assessment of the performance of the entire system.

However, common load models can also be created from the separate load models. The separate and/or common load models can advantageously be used additionally for “machine learning” methods that serve for automatically improving the recognition system.

In an exemplary embodiment isolated phenomenon analysis alone is used for recognizing a load. Preferably spectral analysis and isolated phenomenon analysis together are used for recognition, however. Spectral analysis can be used for confirming and/or corroborating early recognition, i.e. for confirming other classifiers. It can also be used for long-term recognition. The reference values of spectral analysis, the feature vectors, can be part of the device recognition algorithms.

Below an example for a decision criterion for successful recognition is explained. Other decision criteria may also be used, however.

A time “t” represents a moment when a device is switched on or off or when its energy consumption changes. If a load is recognized at a later point in time t±Δ and if it can be clearly allocated to a load profile, it is assessed as “successfully recognized”. This is then considered to be a switching-on event. The same applies correspondingly for the recognition of a switching-off event. In case the device is no longer detected in the signal at a point in time t±Δ, this is assessed as successfully “not recognized” (switching-off event). In case a change of the signal is detected at a point in time t±Δ (change±of the power values) and this is allocated to a successfully recognized load, the change event is assessed as “successfully recognized”. The period of Δ may be specific for individual classes of loads and it may range from several seconds and several minutes, e.g. the typical operation period of a device. Δ may vary by ±20% in the lower time range (seconds) and ±5% in the upper time range (minutes).

Preferably information from a plurality of consumer networks 11 in the data collection 34 and the data base 38 can be taken into account when analysis and recognition are not taking place in the home sector 10 but on a server that is remote from the home sector 10, thus enhancing the precision of recognition. A load that has been recognized in one consumer network 11, e.g. an air-conditioning system, can be recognized faster and more correctly also in another consumer network 11. The user behaviour of a plurality of users can be managed centrally and this may provide an added value for each of these users. Remote processing also allows for the introduction of new classifiers at such a central location without having to make changes in the home sector 10. This is an essential advantage in comparison with the known systems of the state of the art.

1. A method for analyzing and displaying the energy consumption of electric loads comprising the steps of:
providing at least one consumer network (11) comprising a plurality of interconnected electric loads,
sampling (13) the total current, voltage and phase shift of the consumer network (11) with a sampling rate of less than 5 Hz,
transmitting the sampled measured data via the internet (20) to a means for load recognition (32),
receiving the sampled measured data through the internet (20) by the means for load recognition (32),
determining individual loads in the measured data total current, voltage and phase shift by the means for load recognition (32), comprising at least one of the steps formed by the group of steps:
determining temporal regularities of individual loads by means of a spectral analysis of the measured data; and
generating separate and/or joint load models for individual loads by modelling individual phenomena in the measured data by means of classifiers; and
visualizing the energy consumption in the consumer network.

2. The method according to claim 1, wherein there is a plurality of consumer networks (11), and in the means for load recognition (32) the measured data from the plurality of consumer networks (11) are used for determining individual loads in a consumer network (11).

3. The method according to claim 1, wherein the user can confirm or change the recognition of loads in the consumer network (11) through a web service (40).

4. The method according to claim 1, wherein spectral analysis is used for the long-term recognition of loads in the measured data.

5. The method according to claim 1, wherein spectral analysis is used for confirming or corroborating the early recognition of individual phenomena in the measured data.

6. The method according to claim 1, wherein the sampling frequency is less than 2 Hz, preferably less than or equal to 1 Hz, and greater than or equal to 0.5 Hz, preferably greater than or equal to 0.2 Hz.

7. The method according to claim 1, wherein the energy resolution of the sampling is less than 5 watts, preferably less than 2 watts, even more preferably 1 watt.

8. The method according to claim 1, wherein user profiles, historical data, weather data or seasons are taken into account for feature extraction.

9. A system (100) for analyzing and displaying the energy consumption of electric loads comprising:
a consumer network (11) comprising a plurality of interconnected electric loads,
an intelligent electricity meter (13) that is electrically connected with the consumer network (11) and suitable for sampling the total current, voltage and phase shift of the consumer network (11) with a frequency of less than 5 Hz,
a communication module (14) with a first data memory that is suitable for reading out the measured data of the intelligent electricity meter (13) and storing them in a buffer,
a home gateway (16) for reading out the measured data from the communication module (14) and transmitting the measured data through the internet,
a data collection (34) for receiving the measured data transmitted by the home gateway (16),
a means for load recognition (32) adapted to recognize individual loads in the consumer network (11) from the received measured data total current, voltage and phase shift, and to determine temporal regularities of individual loads by means of a spectral analysis of the measured data, and/or to generate load models for individual loads by modelling individual phenomena in the measured data by means of classifiers, and
a visualization unit (40) for displaying the energy consumption of the loads in the consumer network (11).

10. The system according to claim 9, wherein the communication module (14) is integrated in the intelligent electricity meter (13).

11. The method according to claim 9, wherein there is a plurality of consumer networks (11), and in the means for load recognition (32) the measured data from the plurality of consumer networks (11) are used for determining individual loads in a consumer network (11).
